(19) United States
(12) Patent Application Publication
(10) Pub. No.: US 2016/0105799 A1
(43) Pub. Date: Apr. 14, 2016

(54) EVALUATING PRODUCTIVITY COSTS OF ENTERPRISE MOBILITY MANAGEMENT (EMM) TOOLS BASED ON MOBILE DEVICE METRICS

(71) Applicant: CA, INC., New York, NY (US)

(72) Inventor: Vikas Krishna, San Jose, CA (US)

(73) Assignee: CA, INC., New York, NY (US)

(21) Appl. No.: 14/511,731

(22) Filed: Oct. 10, 2014

(51) Int. Cl. H04W 12/08; H04L 29/06

(52) U.S. Cl. CPC H04W 12/08; H04L 63/1408

(57) ABSTRACT

A method includes performing operations as follows on a processor: receiving metrics from a mobile device associated with the operation of an Enterprise Mobility Management (EMM) tool on the mobile device and generating a score based on the metrics that were received that is indicative of a user productivity cost associated with the EMM tool when using the mobile device.

### BACKGROUND

The present disclosure relates to computing systems, and, in particular, to security management of mobile devices and/or applications.

Enterprises have employees and/or customers that download applications onto their mobile devices, such as smart phones, tablets, laptops, and the like. These applications may allow the users to access various types of content and data belonging to the enterprise. Because mobile devices may be more susceptible to being stolen, misplaced, or compromised in some way, enterprises may deploy a set of security tools known as Enterprise Mobility Management (EMM) tools that may provide a security layer around the mobile applications. These EMM tools may be used to provide security functionality with respect to the mobile applications, the content accessed by the mobile applications, and/or the data used by the mobile applications. The EMM tools may implement rules and/or policies to ensure that the applications/content/data are secure. For example, the EMM tools may protect the applications by requiring enhanced login credentials depending on the time of day the application is being accessed (e.g., not during work hours), the geographic location of the mobile device, and the like. Similarly, the EMM tools may protect the content/data associated with the applications by enforcing various restrictions and policies that limit access to the content/data. While the EMM tools may be helpful in protecting the enterprise, the security measures may also have a negative effect on productivity due to the additional steps that users must take to gain access to mobile applications, content, and/or data.

### SUMMARY

In some embodiments of the inventive subject matter, a method comprises performing operations as follows on a processor: receiving metrics from a mobile device associated with the operation of an Enterprise Mobility Management (EMM) tool on the mobile device and generating a score based on the metrics that were received that is indicative of a user productivity cost associated with the EMM tool when using the mobile device.

In further embodiments of the inventive subject matter, a system comprises a processor and a memory coupled to the processor and comprising computer readable program code embodied in the memory that when executed by the processor causes the processor to perform operations comprising: receiving metrics from a mobile device associated with the operation of an Enterprise Mobility Management (EMM) tool on the mobile device and generating a score based on the metrics that were received that is indicative of a user productivity cost associated with the EMM tool when using the mobile device.

In other embodiments of the inventive subject matter, a computer program product comprises a tangible computer readable storage medium comprising computer readable program code embodied in the medium that when executed by a processor causes the processor to perform operations comprising: receiving metrics from a mobile device associated with the operation of an Enterprise Mobility Management (EMM) tool on the mobile device and generating a score based on the metrics that were received that is indicative of a user productivity cost associated with the EMM tool when using the mobile device.

Other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram of a system for evaluating productivity costs of enterprise mobility management (EMM) tools based on mobile device metrics in accordance with some embodiments of the inventive subject matter.

FIG. 2 illustrates a data processing system that may be used to implement the EMM tool assessment server of FIG. 1 in accordance with some embodiments of the inventive subject matter.

FIG. 3 is a block diagram that illustrates a software/hardware architecture for evaluating productivity costs of EMM tools based on mobile device metrics in accordance with some embodiments of the present inventive subject matter.

FIG. 4 is a block diagram that illustrates an electronic device/mobile terminal in accordance with some embodiments of the present inventive subject matter.

FIGS. 5 and 6 are flowcharts that illustrate operations for evaluating productivity costs of EMM tools based on mobile device metrics in accordance with some embodiments of the inventive subject matter.

### DETAILED DESCRIPTION

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

As used herein, a “service” includes, but is not limited to, a software and/or hardware service, such as cloud services in which software, platforms, and infrastructure are provided remotely through, for example, the Internet. A service may be provided using Software as a Service (SaaS), Platform as a Service (PaaS), and/or Infrastructure as a Service (IaaS) delivery models. In the SaaS model, customers generally access software residing in the cloud using a thin client, such as a browser, for example. In the PaaS model, the customer typically creates and deploys the software in the cloud sometimes using tools, libraries, and routines provided through the cloud service provider. The cloud service provider may provide the network, servers, storage, and other tools used to host the customer's application(s). In the IaaS model, the cloud service provider provides physical and/or virtual machines along with hypervisor(s). The customer installs operating system images along with application software on the physical and/or virtual infrastructure provided by the cloud service provider.

As used herein, the term “data processing facility” includes, but it not limited to, a hardware element, firmware component, and/or software component. A data processing system may be configured with one or more data processing facilities.

As used herein, the term “mobile terminal” or “mobile device” may include a satellite or cellular radiotelephone with or without a multi-line display; a Personal Communications System (PCS) terminal that may combine a cellular radiotelephone with data processing, facsimile and data communications capabilities; a PDA or smart phone that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals or mobile devices may also be referred to as “pervasive computing” devices.

Some embodiments of the inventive subject matter stem from a realization that an enterprise mobility management (EMM) tool assessment module may be associated with an EMM tool that can collect quantitative metrics on efficacy of the EMM tool. For example, measurements can be taken for how much time users spend in various parts of an application complying with a security measure/policy, how much time a user spends logging in and complying with multi-factor security protocols, and the like. Qualitative feedback can be obtained from users based on surveys questionnaires and the like. A score may be generated based on the quantitative and qualitative metrics and this score may be used to make recommendations in deploying EMM tools. An evaluation may also be made regarding the potential cost that could be incurred if the EMM tool was not in place due to the loss of an enterprise's sensitive information. The potential cost associated with a security breach may be weighed against the productivity cost associated with the EMM tool in making a recommendation whether to keep or remove the EMM tool.

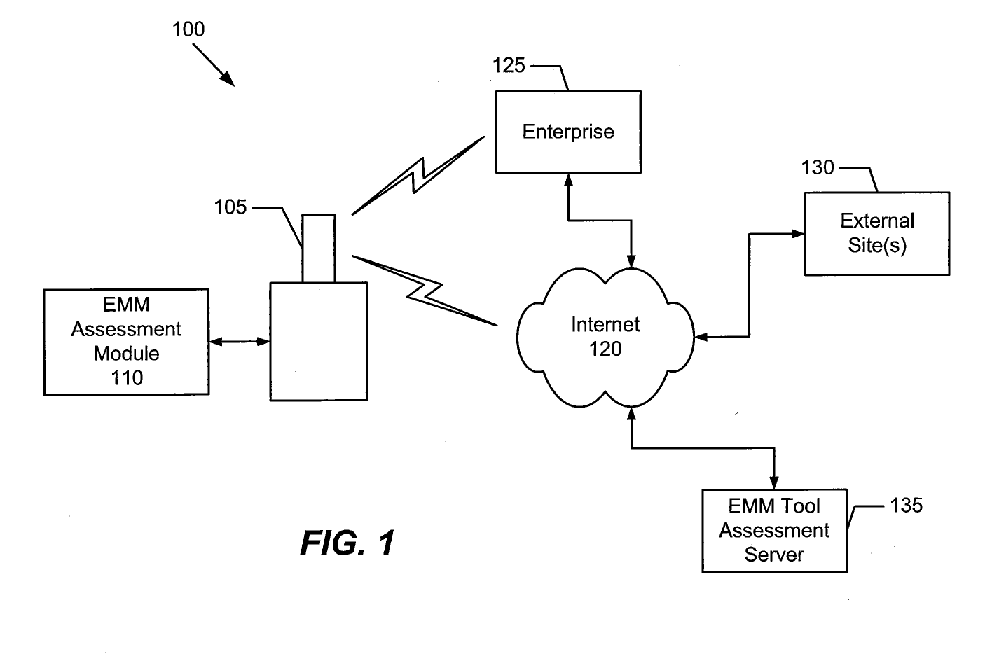

FIG. 1 is a block diagram of a system for evaluating productivity costs of EMM tools based on mobile device metrics according to some embodiments of the inventive subject matter. Employees and/or customers of an enterprise, for example, may use mobile devices, such as smart phones, tablets, laptops, and the like to access various types of content and data belonging to the enterprise. As shown in FIG. 1, a mobile device 105 may be used to communicate with an enterprise 125 using a direct wireless connection or via various networks, which are represented by the Internet 120. In addition to communicating with the enterprise 125, the mobile device may also communicate with other external site(s) 130 to run application(s) and/or exchange data and content therewith. Because mobile devices are typically more susceptible to being stolen, lost, or compromised versus desktop computing devices, the enterprise 125 may use EMM tools to provide additional security functionality with respect to the mobile applications, the content accessed by the mobile applications, and/or the data used by the mobile applications. As described above, the EMM tools may implement rules and/or policies to ensure that the enterprise's applications/content/data are secure by requiring enhanced login credentials depending on the time of day the application is being accessed (e.g., not during work hours), the geographic location of the mobile device, and the like. Content/data associated with the applications by enforcing various restrictions and policies that limit access to the content/data.

A tradeoff that may come with the improved security, however, is a reduction in user productivity. According to some embodiments of the inventive subject matter, the enterprise 125 may cooperate with an EMM tool assessment server 135, which provides a service to evaluate the efficacy of an EMM tool. The EMM tool assessment server 135 may provide an EMM assessment module 110 that can be downloaded to the mobile device 105 and associated with an EMM tool for which quantitative and/or qualitative metrics are to be collected. The EMM assessment module 110 is configured to collect quantitative and/or qualitative metric data associated with an EMM tool and communicate the collected data back to the EMM tool assessment server 135, which is configured to process the data and generate an evaluation of the efficacy of the EMM tool.

As shown in FIG. 1, the connections between the enterprise 125, external sites 130, EMM tool assessment server 135, and the mobile device 105 may include wireless and/or wireline connections and may be direct or include one or more intervening local area networks, wide area networks, and/or the Internet. The network 120 may be a global network, such as the Internet or other publicly accessible network. Various elements of the network 120 may be interconnected by a wide area network, a local area network, an Intranet, and/or other private network, which may not be accessible by the general public. Thus, the communication network 120 may represent a combination of public and private networks or a virtual private network (VPN). The network 120 may be a wireless network, a wireline network, or may be a combination of both wireless and wireline networks.

Although FIG. 1 illustrates a system for evaluating productivity costs of EMM tools based on mobile device metrics according to some embodiments of the inventive subject matter it will be understood that embodiments of the present invention are not limited to such configurations, but are intended to encompass any configuration capable of carrying out the operations described herein.

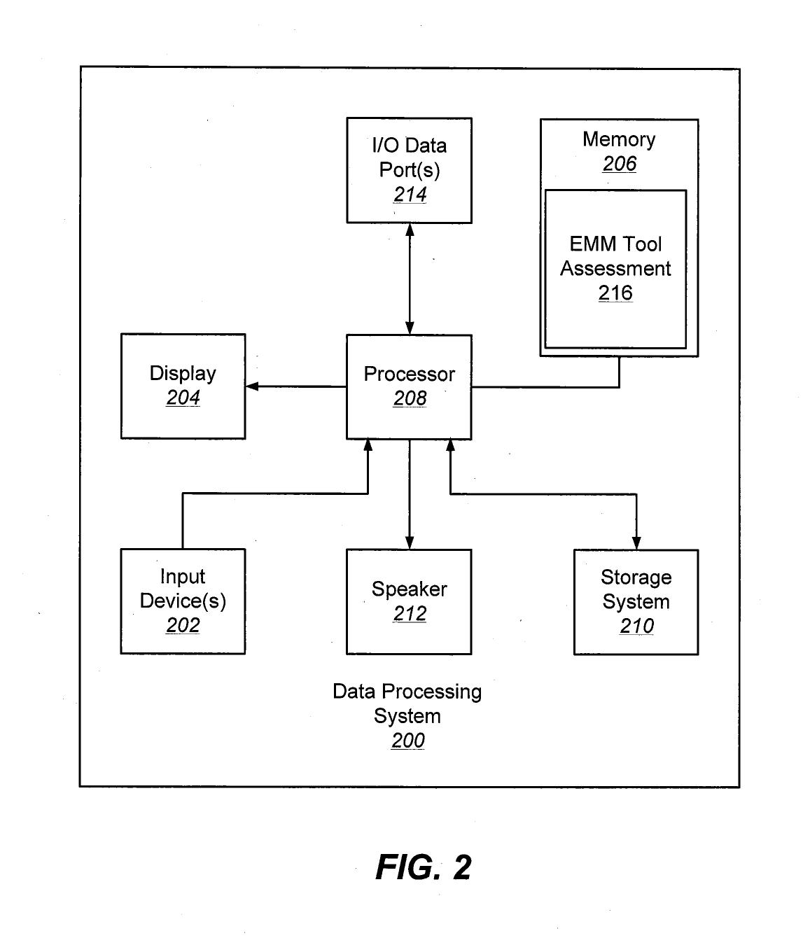

Referring now to FIG. 2, a data processing system 200 that may be used to implement the EMM tool assessment server 135 of FIG. 1, in accordance with some embodiments of the inventive subject matter, comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, hard disks, or the like, as well as virtual storage, such as a RAMDISK. The I/O data port(s) 214 may be used to transfer information between the data processing system 200 and another computer system or a network (e.g., the Internet). These components may be conventional components, such as those used in many conventional computing devices, and their functionality, with respect to conventional operations, is generally known to those skilled in the art. The memory 206 may be configured with a EMM tool assessment module 216 that may be configured to generate evaluate productivity costs of EMM tools based on mobile device metrics according to some embodiments of the inventive subject matter.

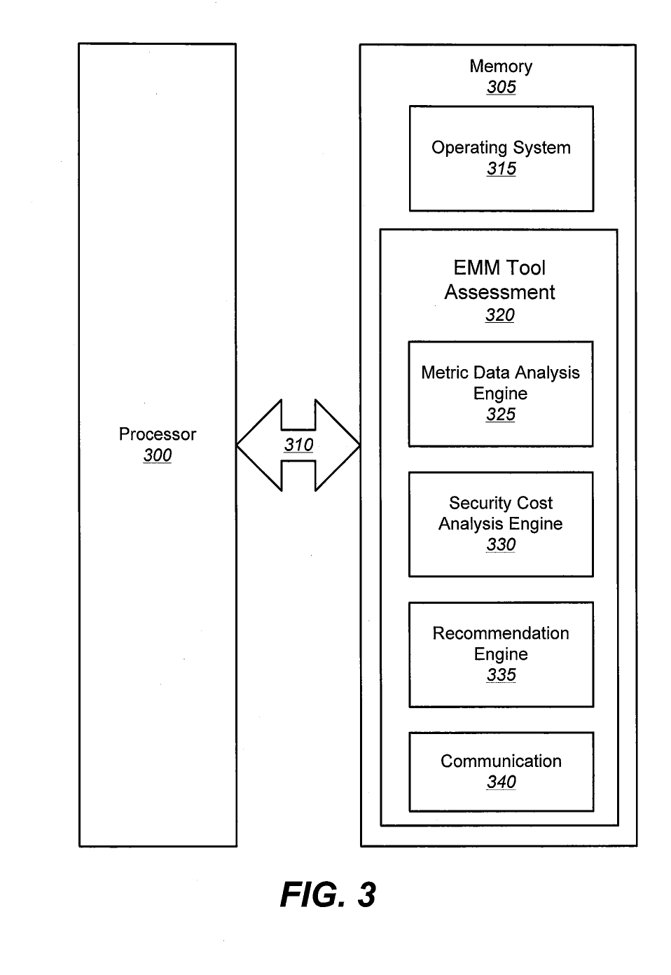

FIG. 3 illustrates a processor 300 and memory 305 that may be used in embodiments of data processing systems, such as the EMM tool assessment server 135 of FIG. 1 and the data processing system 200 of FIG. 2, respectively, for evaluating productivity costs of EMM tools based on mobile device metrics, according to some embodiments of the inventive subject matter. The processor 300 communicates with the memory 305 via an address/data bus 310. The processor 300 may be, for example, a commercially available or custom microprocessor. The memory 305 is representative of the one or more memory devices containing the software and data used for generating a proposal for selection of specific services from one or more cloud service providers in accordance with some embodiments of the inventive subject matter. The memory 305 may include, but is not limited to, the following types of devices: cache, ROM, PROM, EPROM, EEPROM, flash, SRAM, and DRAM.

As shown in FIG. 3, the memory 305 may contain up to two or more categories of software and/or data: an operating system 315 and an EMM tool assessment module 320. The operating system 315 generally controls the operation of the data processing system. In particular, the operating system 315 may manage the data processing system's software and/or hardware resources and may coordinate execution of programs by the processor 300. The EMM tool assessment module 320 may be configured to receive quantitative and/or qualitative EMM tool metric data from an EMM assessment module 110 that is downloaded to a mobile device 105 and, based on the received data, evaluate productivity costs associated with the EMM tool. The EMM tool assessment module 320 comprises a metric data analysis engine 325, a security cost analysis engine 330, a recommendation engine 335, and a communication module 340.

The metric data analysis engine 325 may be configured to receive the quantitative and/or qualitative metric data from the EMM assessment module 110 on the mobile device 105. These quantitative metrics may include, but are not limited to, an amount of time a user spends in an application on the mobile device complying with a security measure and an amount of time a user spends complying with a multi-factor security protocol to log in to the mobile device. The qualitative metrics may include feedback from a user of the mobile device regarding operation of the EMM tool and/or answers to survey questions provided to the user of the mobile device. The EMM assessment module 110 may have a built-in qualitative feedback mechanism where the user can provide feedback to the EMM tool assessment server 135 and/or answer survey questions and/or the EMM assessment module 110 may provide a link, such as a Uniform Resource Locator (URL), which the user can invoke to access a Web page, for example, to provide the qualitative feedback information. Based on the metric data received from the EMM assessment module 110, the metric data analysis engine 325 may evaluate the efficacy of the EMM tool based on the metric data that is indicative of a user productivity cost associated with the EMM tool when using the mobile device.

The security costs analysis engine 330 may be configured to generate an assessment based on a functionality of the EMM tool that is indicative of a security cost associated with the mobile device when the EMM tool is not installed on the device. This assessment may be indicative of the potential cost of a breach in security with respect to the application/content/data that the EMM tool is used to protect.

The recommendation engine 335 may be configured to receive input from the metric data analysis engine 325 and generate scores based on the quantitative and/or qualitative metric data that is indicative of the user productivity cost associated with the EMM tool. Scores may be generated separately for the quantitative and qualitative metric data along with a composite score that is based on both the quantitative and qualitative metric data scores. The recommendation engine 335 may also receive input from the security costs analysis engine 330 regarding the assessment security cost associated with removal of the EMM tool. The recommendation engine 335 may generate a score indicative of the security cost associated with removal of the EMM tool, which can be compared with the score(s) based on the quantitative and/or qualitative metric data indicative of the productivity cost associated with the EMM tool to evaluate the efficacy of the EMM tool and generate a recommendation whether to remove the EMM tool or continue to deploy the EMM tool on the mobile device 105. This recommendation can then be communicated to the enterprise 125 for use by information technology security personnel, for example.

The communication module 340 may be configured to facilitate communication between the EMM tool assessment server 135 and other entities, such as the mobile device 105 and enterprise 125.

Although FIG. 3 illustrates hardware/software architectures that may be used in data processing systems, such as the EMM tool assessment server 135 of FIG. 1 and the data processing system 200 of FIG. 2, respectively, for evaluating productivity costs of EMM tools based on mobile device metrics, according to some embodiments of the inventive subject matter, it will be understood that the present invention is not limited to such a configuration but is intended to encompass any configuration capable of carrying out operations described herein.

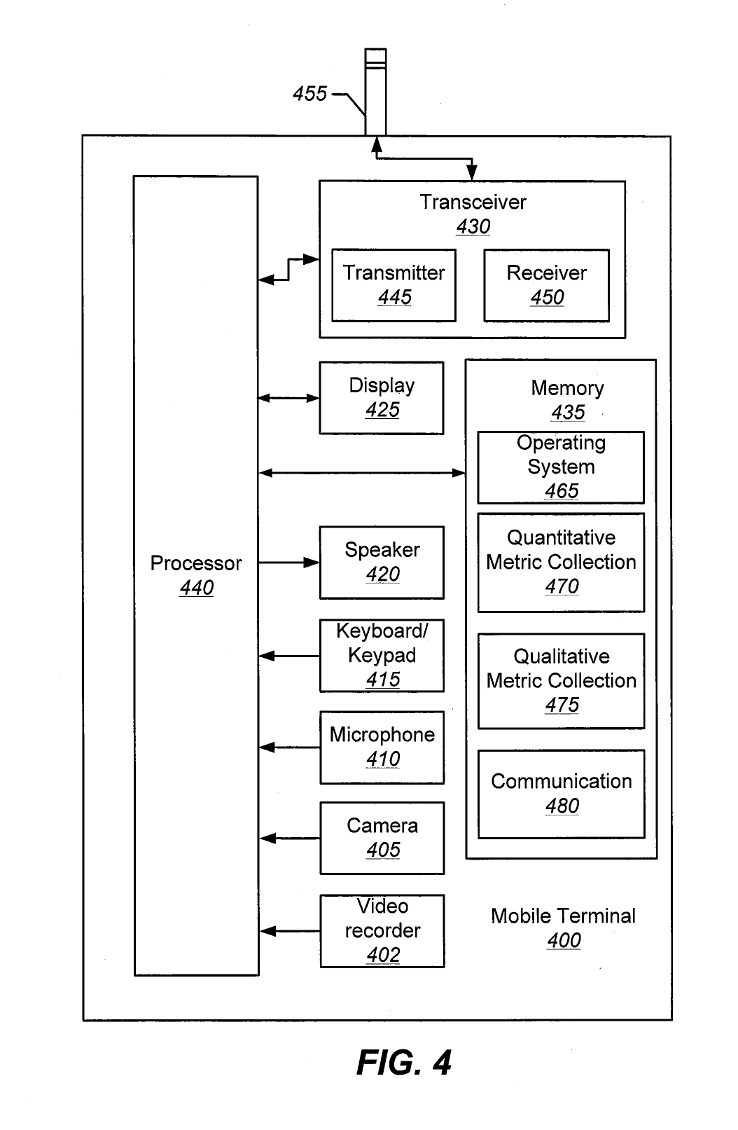

Referring now to FIG. 4, an exemplary mobile terminal 400 that may be used to implement the mobile terminal 105 of FIG. 1, in accordance with some embodiments of the inventive subject matter, includes a video recorder 402, a camera 405, a microphone 410, a keyboard/keypad 415, a speaker 420, a display 425, a transceiver 430, and a memory 435 that communicate with a processor 440. The transceiver 430 comprises a transmitter circuit 445 and a receiver circuit 450, which respectively transmit outgoing radio frequency signals to base station transceivers and receive incoming radio frequency signals from the base station transceivers via an antenna 455. The radio frequency signals transmitted between the mobile terminal 400 and the base station transceivers may comprise both traffic and control signals (e.g., paging signals/messages for incoming calls), which are used to establish and maintain communication with another party or destination. The radio frequency signals may also comprise packet data information, such as, for example, cellular digital packet data (CDPD) information. The foregoing components of the mobile terminal 300 may be included in many conventional mobile terminals and their functionality is generally known to those skilled in the art.

The processor 440 communicates with the memory 435 via an address/data bus. The processor 440 may be, for example, a commercially available or custom microprocessor. The memory 435 is representative of the one or more memory devices containing the software and data used to provide a phone-based Web server with a private IP address, in accordance with some embodiments of the present invention. The memory 435 may include, but is not limited to, the following types of devices: cache, ROM, PROM, EPROM, EEPROM, flash, SRAM, and DRAM.

As shown in FIG. 4, the memory 435 may contain up to three or more categories of software and/or data: the operating system 465, a quantitative metric collection module 470, a qualitative metric collection module 475, and a communication module 480. The quantitative metric collection module 470 and qualitative metric collection module 475 may be used to implement the EMM assessment module 110 of FIG. 1. The quantitative metric collection module 470 may be configured to collect quantitative metric data associated with the use of an EMM tool on the mobile device 105/400. These quantitative metrics may include, but are not limited to, an amount of time a user spends in an application on the mobile device complying with a security measure and an amount of time a user spends complying with a multi-factor security protocol to log in to the mobile device.

The qualitative metric collection module 475 may be configured to collect qualitative metric data associated with the use of an EMM tool on the mobile device. The qualitative metrics may include feedback from a user of the mobile device regarding operation of the EMM tool and/or answers to survey questions provided to the user of the mobile device. The EMM qualitative metric collection module 475 may have a built-in qualitative feedback mechanism where the user can provide feedback to the EMM tool assessment server 135 and/or answer survey questions and/or the qualitative metric collection module 475 may provide a link, such as a Uniform Resource Locator (URL), which the user can invoke to access a Web page, for example, to provide the qualitative feedback information.

The communication module 480 may be configured to facilitate communication between the mobile terminal 105/400 and other entities, such as the enterprise 125, EMM tool assessment server 135, and external site(s) 130.

Although FIG. 4 illustrates an exemplary software and hardware architecture that may be used to provide a mobile terminal that can receive an EMM assessment module 110 for storage thereon to collect quantitative and/or qualitative metric data associated with the operation of an EMM tool according to some embodiments of the inventive subject matter, it will be understood that embodiments of the present invention are not limited to such a configuration, but are intended to encompass any configuration capable of carrying out the operations described herein.

Computer program code for carrying out operations of data processing systems discussed above with respect to FIGS. 1-4 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the EMM tool assessment server 105 of FIG. 1, the data processing system 200 of FIG. 2, the hardware/software architecture of FIG. 3, and the mobile terminal of FIG. 4 may each be implemented as a single processor system, a multi-processor system, a multi-core processor system, or even a network of stand-alone computer systems, in accordance with various embodiments of the inventive subject matter. Each of these processor/computer systems may be referred to as a “processor” or “data processing system.” It will be further understood that although FIGS. 1-3 illustrate the functionality of the EMM tool assessment server 135 as providing EMM tool assessment functionality as a separate service to the enterprise 125, in other embodiments, the functionality of the EMM tool assessment server 135 may be implemented as part of the data processing facilities of the enterprise 125.

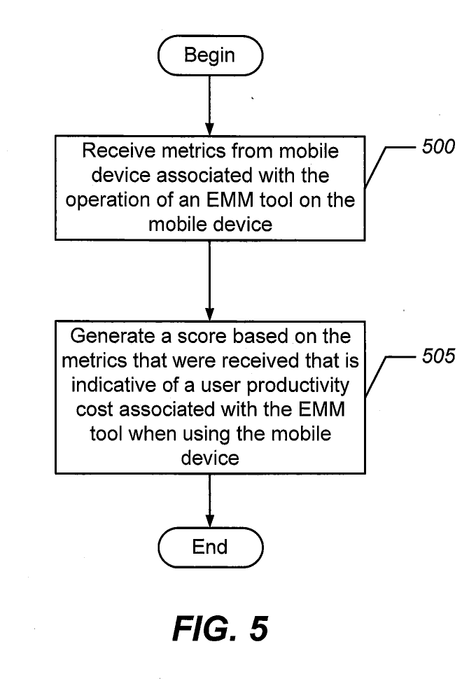

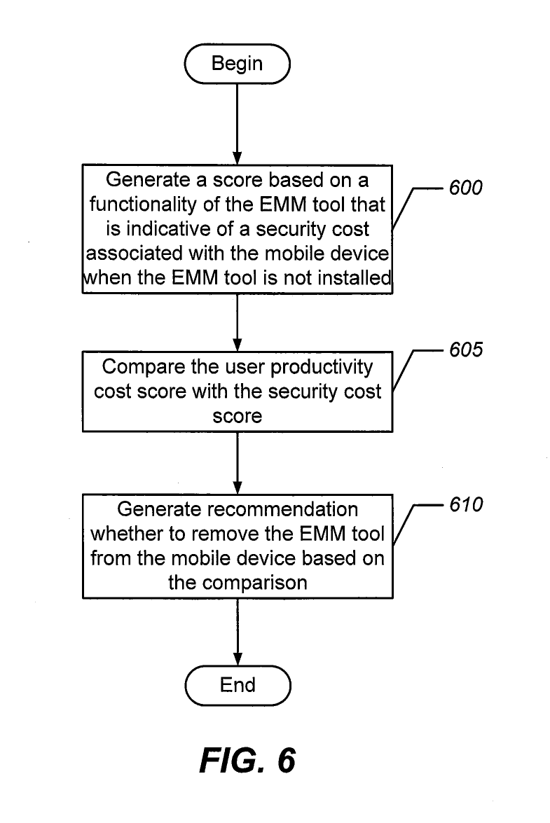

FIGS. 5 and 6 are flowcharts that illustrate operations for evaluating productivity costs of EMM tools based on mobile device metrics in accordance with some embodiments of the inventive subject matter. Referring to FIG. 5, operations begin at block 500 where the metric data analysis engine 325 on the EMM tool assessment server 135 receives metric data from the EMM assessment module 110, which runs on a mobile device 105/400. The metric data may comprise quantitative metric data and/or qualitative metric data as described above. The recommendation engine 335 may generate a score at block 505 based on one or both of the quantitative and qualitative metric data that is indicative of a user productivity cost associated with the EMM tool when using the mobile device 105/400. In some embodiments, for example, the recommendation engine 335 may generate a first scored based on the quantitative metric data that is indicative a user productivity cost associated with the EMM tool when using the mobile device 105/400 and a second score based on the qualitative metric data that is indicative a user productivity cost associated with the EMM tool when using the mobile device 105/400. The score may then be generated by combining the first and second scores, which results in a composite score.

The score generated that is indicative of a user productivity cost associated with the EMM tool when using the mobile device 105/400 may appear to indicate that a high the tool imposes a relatively high cost in terms of user productivity. It may be useful, however, to consider the costs associated with risks incurred if the EMM tool were not deployed on the mobile device 105/400. Referring to FIG. 6, operations begin at block 600 where the security cost analysis engine 330 generates an assessment based on a functionality of the EMM tool that is indicative of a security cost associated with the mobile device when the EMM tool is not installed on the device. This assessment is provided to the recommendation engine 335, which generates a score indicative of the security cost associated with removal of the EMM tool (i.e., the cost associated with the security risk when the EMM tool is not deployed on the mobile device 105/400). At block 605, the recommendation engine 335 compares the score indicative of the security cost associated with removal of the EMM tool with the score(s) based on the quantitative and/or qualitative metric data indicative of the productivity cost associated with the EMM tool to evaluate the efficacy of the EMM tool. A recommendation is generated at block 610 whether to remove the EMM tool or continue to deploy the EMM tool on the mobile device 105 based on the comparison of the scores indicative of the security costs associated with removal of the EMM tool and the productivity costs associated with continued deployment of the EMM tool.

The embodiments of methods, systems, and computer program products described herein may provide an EMM tool assessment module that may be downloaded to a mobile device and associated with the EMM tool for which quantitative metrics are to be collected. The EMM tool assessment module may communicate quantitative metric data back to an EMM tool assessment server, which may process the data to generate an evaluation of the efficacy of the EMM tool. Users of the mobile device may also be provided with a survey or other mechanism for providing qualitative feedback on the EMM tool. This qualitative feedback mechanism may be built into the EMM tool assessment module or the EMM tool assessment module may provide a link to where the user can provide such feedback. The EMM tool assessment server may include a security cost analysis engine that can assess the potential cost of a breach in security with respect to the application/content/data that a particular EMM tool is used to protect. The EMM tool assessment server may further include a recommendation engine that can generate scores based on the quantitative metric data and/or the qualitative metric data. The recommendation engine may accept input from the security cost analysis engine and generate a recommendation whether to keep or remove the EMM tool based on the quantitative and/or qualitative scores and the cost information associated with a security breach.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

That which is claimed:

1. A method, comprising:
performing operations as follows on a processor:
receiving metrics from a mobile device associated with the operation of an Enterprise Mobility Management (EMM) tool on the mobile device; and
generating a score based on the metrics that were received that is indicative of a user productivity cost associated with the EMM tool when using the mobile device.

2. The method of claim 1, further comprising:
generating a score based on a functionality of the EMM tool that is indicative of a security cost associated with the mobile device when the EMM tool is not installed on the mobile device.

3. The method of claim 2, further comprising:
comparing the score that is indicative of the user productivity cost associated with the EMM tool with the score that is indicative of the security cost associated with the mobile device; and
generating a recommendation whether to remove the EMM tool from the mobile device based on comparing the score that is indicative of the user productivity cost associated with the EMM tool with the score that is indicative of the security cost associated with the mobile device.

4. The method of claim 1, wherein the metrics comprise quantitative metrics and qualitative metrics.

5. The method of claim 4, wherein generating the score based on the metrics comprises:
generating a first score based on the quantitative metrics that were received that is indicative of the user productivity cost associated with the EMM tool when using the mobile device;
generating a second score based on the qualitative metrics that were received that is indicative of the user productivity cost associated with the EMM tool when using the mobile device; and
combining the first score and the second score.

6. The method of claim 4, wherein the quantitative metrics comprise:
an amount of time a user spends in an application on the mobile device complying with a security measure; and
an amount of time a user spends complying with a multi-factor security protocol to log in to the mobile device.

7. The method of claim 4, wherein the qualitative metrics comprise:
feedback from the user of the mobile device regarding operation of the EMM tool.

8. The method of claim 7, wherein the feedback from the user comprises:
answers to survey questions provided to the user of the mobile device.

9. A system, comprising:
a processor; and
a memory coupled to the processor and comprising computer readable program code embodied in the memory that when executed by the processor causes the processor to perform operations comprising:
receiving metrics from a mobile device associated with the operation of an Enterprise Mobility Management (EMM) tool on the mobile device; and
generating a score based on the metrics that were received that is indicative of a user productivity cost associated with the EMM tool when using the mobile device.

10. The system of claim 9, wherein the operations further comprise:
generating a score based on a functionality of the EMM tool that is indicative of a security cost associated with the mobile device when the EMM tool is not installed on the mobile device;
comparing the score that is indicative of the user productivity cost associated with the EMM tool with the score that is indicative of the security cost associated with the mobile device; and
generating a recommendation whether to remove the EMM tool from the mobile device based on comparing the score that is indicative of the user productivity cost associated with the EMM tool with the score that is indicative of the security cost associated with the mobile device.

11. The system of claim 9, wherein the metrics comprise quantitative metrics and qualitative metrics and wherein generating the score based on the metrics comprises:
generating a first score based on the quantitative metrics that were received that is indicative of the user productivity cost associated with the EMM tool when using the mobile device;
generating a second score based on the qualitative metrics that were received that is indicative of the user productivity cost associated with the EMM tool when using the mobile device; and
combining the first score and the second score.

12. The system of claim 11, wherein the quantitative metrics comprise:
an amount of time a user spends in an application on the mobile device complying with a security measure; and
an amount of time a user spends complying with a multi-factor security protocol to log in to the mobile device; and
wherein the qualitative metrics comprise:
feedback from the user of the mobile device regarding operation of the EMM tool.

13. A computer program product, comprising:
a tangible computer readable storage medium comprising computer readable program code embodied in the medium that when executed by a processor causes the processor to perform operations comprising:
receiving metrics from a mobile device associated with the operation of an Enterprise Mobility Management (EMM) tool on the mobile device; and
generating a score based on the metrics that were received that is indicative of a user productivity cost associated with the EMM tool when using the mobile device.

14. The computer program product of claim 13, wherein the operations further comprise:
generating a score based on a functionality of the EMM tool that is indicative of a security cost associated with the mobile device when the EMM tool is not installed on the mobile device.

15. The computer program product of claim 14, wherein the operations further comprise:
comparing the score that is indicative of the user productivity cost associated with the EMM tool with the score that is indicative of the security cost associated with the mobile device; and
generating a recommendation whether to remove the EMM tool from the mobile device based on comparing the score that is indicative of the user productivity cost associated with the EMM tool with the score that is indicative of the security cost associated with the mobile device.

16. The computer program product of claim 13, wherein the metrics comprise quantitative metrics and qualitative metrics.

17. The computer program product of claim 16, wherein generating the score based on the metrics comprises:
generating a first score based on the quantitative metrics that were received that is indicative of the user productivity cost associated with the EMM tool when using the mobile device;
generating a second score based on the qualitative metrics that were received that is indicative of the user productivity cost associated with the EMM tool when using the mobile device; and
combining the first score and the second score.

18. The computer program product of claim 16, wherein the quantitative metrics comprise:
an amount of time a user spends in an application on the mobile device complying with a security measure; and
an amount of time a user spends complying with a multi-factor security protocol to log in to the mobile device.

19. The computer program product of claim 16, wherein the qualitative metrics comprise:
feedback from the user of the mobile device regarding operation of the EMM tool.

20. The computer program product of claim 19, wherein the feedback from the user comprises:
answers to survey questions provided to the user of the mobile device.
